(19) United States
(12) Patent Application Publication
(10) Pub. No.: US 2010/0076945 A1
(43) Pub. Date: Mar. 25, 2010

(54) SYSTEM AND METHOD FOR PROVIDING BUSINESS INFORMATION TO A COMMUNICATION DEVICE

(75) Inventor: CHIH-CHIEN CHU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/491,240

(22) Filed: Jun. 25, 2009

(30) Foreign Application Priority Data
Sep. 5, 2008 (CN) 200810304379.X

(51) Int. Cl. G06F 17/30; H04H 20/71; G06F 15/16

(52) U.S. Cl. 707/705; 455/3.01; 707/E17.108; 709/206

(57) ABSTRACT

A system and method for providing business information to a communication device include partitioning a region for each base station, and creating a database to store business information of each region. The system and method further include receiving a query request from the communication device through a base station, determining a region corresponding to the base station, and sending business information of the determined region to the communication device.

### BACKGROUND

1. Technical Field

Embodiments of the present disclosure relate to managing information, and more particularly to a system and method for providing business information to a communication device.

2. Description of Related Art

Communication devices (e.g., mobile phones) provide various functionalities for people, such as to search information through a communication network, etc. For example, people may search the Internet for business information of a specified trade company (e.g., marketplaces, restaurants, etc.) using the mobile phones. However, people cannot acquire business information of different trade companies that are close to locations of people automatically.

What is needed, therefore, is an improved system and method for providing business information to a communication device.

### BRIEF DESCRIPTION OF THE DRAWINGS

FIG. 1 is a block diagram of one embodiment of a server in communication with a plurality of communication devices through a plurality of base stations.

FIG. 2 is a block diagram of one embodiment of the server comprising a providing system.

FIG. 3 is a flowchart of one embodiment of a method for providing business information to a communication device.

FIG. 4 is a schematic diagram of one embodiment of a distribution of base stations.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

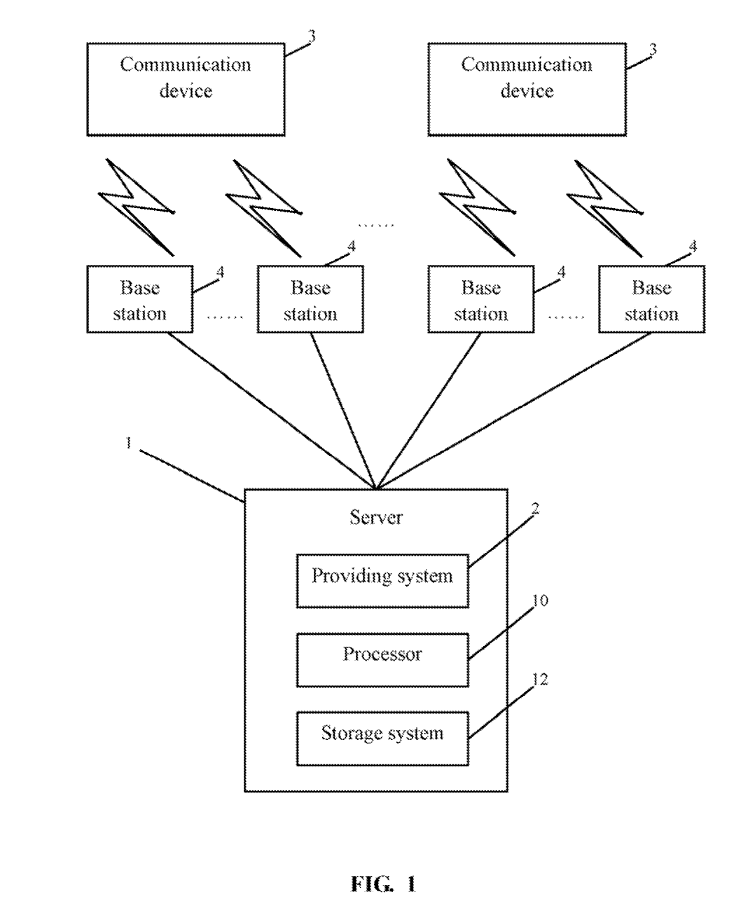

FIG. 1 is a block diagram of one embodiment of a server 1 in communication with a plurality of communication devices 3 through a plurality of base stations 4. The server 1 may be a host computer, for example. In one embodiment, the server 1 may be a web server, which provides a website including various webpages for people to query, browse, or preset query conditions, for example.

The server 1 may include a providing system 2, a processor 10 and a storage system 12. The providing system 2 may be used to provide business information to the plurality of communication devices 3. In one embodiment, the providing system 2 is included in a computer readable medium of a server 1. In another embodiment, the providing system 2 may be included in an operating system of the server 1.

The processor 10 executes one or more computerized operations of the server 1 and other applications, to provide functions of the server 1. The storage system 12 stores one or more programs, such as programs of an operating system, other applications of the server 1, and various kinds of data, such as business information, for example. In one embodiment, the storage system 12 may include a hard disk of the server 1.

In one embodiment, the plurality of base stations 4 may be wireless base stations or mobile telephone base stations, for example. Each base station 4 emits radio signals periodically, and each communication device 3 within a range of each base station 4 may identify a nearest base station 4 after receiving the radio signals. The plurality of communication devices 3 may be mobile phones, personal digital assistants (PDAs), or any other kind of computing device, for example. Users of the plurality of communication devices 3 may access the server 1 to acquire information through the plurality of base stations 4.

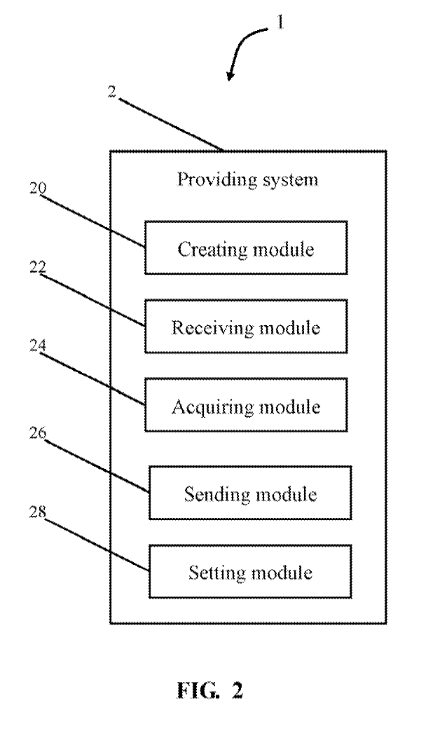

FIG. 2 is a block diagram of one embodiment of the server 1 comprising the providing system 2. In one embodiment, the providing system 2 includes a creating module 20, a receiving module 22, an acquiring module 24, a sending module 26, and a setting module 28. The modules 20, 22, 24, 26, and 28 may comprise one or more computerized operations to be executed by the processor 10 to perform one or more operations of the server 1, to collect and store the business information, and provide the business information to the plurality of communication devices 3.

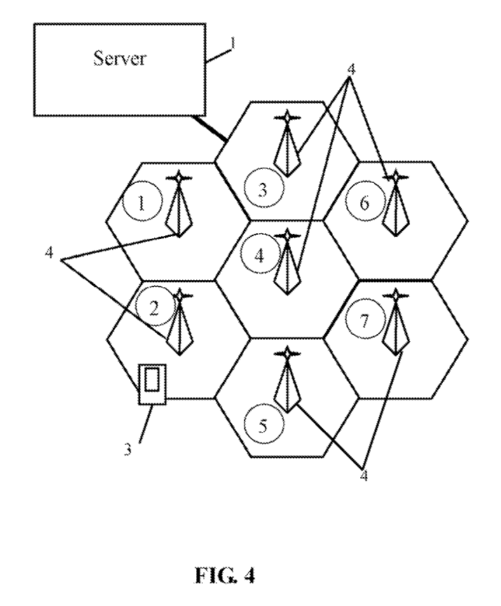

The creating module 20 partitions a region for each of the plurality of base station 4 according to distribution ranges of the plurality of base stations 4 and a cover region of radio signals of each of the plurality of base station 4. For example, if a city has 100 base stations, then the city may be divided into 100 regions. The creating module further assigns an identification (ID) number for each of the plurality of base stations 4. Referring to FIG. 4, the distribution ranges of the plurality of base stations 4 and the region of each of the plurality of base stations 4 are shown. As shown, the communication device 3 is connected to the server 1 through a base station 4 having an ID number “2.” In one embodiment, the ID number of each of the plurality of base stations 4 may be numerical, alphabetical, etc.

The creating module 20 also creates a database in the storage system 12, and stores business information of a plurality of businesses of each region into the database. The business information may include, but are not limited to names, classifications, addresses, contact phone numbers, and preferential information of various trade companies in each region, for example. In one embodiment, the classifications of the trade companies may include marketplaces, restaurants, hotels, entertainment places, etc. The business information may be collected from the Internet or uploaded by the trade companies.

In one embodiment, the providing system 2 provides a query webpage for users to query business information in the storage system 12. The user of the communication device 3 may access the query webpage when a communication between the communication device 3 and the server 1 is established through a base station 4, and send a query request to the providing system 2 so as to query business information of a region that the base station 4 belongs to. In one embodiment, the query request may be input through the query webpage directly, or sent to the providing system 2 through a message in a predefined format, which may be preset by the setting module 28.

The receiving module 22 receives the query request from the communication device 3 through the base station 4. The acquiring module 24 acquires an ID number of the base station 4 that connects the server 1 with the communication device 3, and determines the region corresponding to the base station 4.

The sending module 26 acquires business information of the determined region from the database in the storage system 12, and sends the acquired business information to the communication device 3 through the base station 4.

In one embodiment, if the base station 4 is a wireless base station, the base station 4 may acquire a media access control (MAC) address of the communication device 3 when transmitting the query request from the communication device 3 to the server 1. Then the base station 4 may send the acquired business information from the server 1 to the communication device 3 according to the acquired MAC address of the communication device 3.

In another embodiment, if the base station 4 is a mobile telephone base station, the base station 4 may acquire a subscriber identity module (SIM) card number of the communication device 3 when transmitting the query request from the communication device 3 to the server 1. Then the base station 4 may send the acquired business information from the server 1 to the communication device 3 according to the acquired SIM card number of the communication device 3.

Depending on the embodiment, the setting module 28 may be operable to preset query conditions to query specified business information. In one embodiment, the query condition may be used to query business information of one or more specified trade companies, query business information of one or more trade companies in a specified classification, or query business information of one or more trade companies providing preferential prices, etc. In one embodiment, the user of the communication device 3 wants to query business information of all Chinese restaurants. The business information of the Chinese restaurants may include a restaurant address and a phone number of each Chinese restaurant, special foods of each Chinese restaurant, for example. The sending module 26 searches the database for the specified business information according to the preset query conditions, and sends the specified business information to the communication device 3 using messages, E-mails, etc.

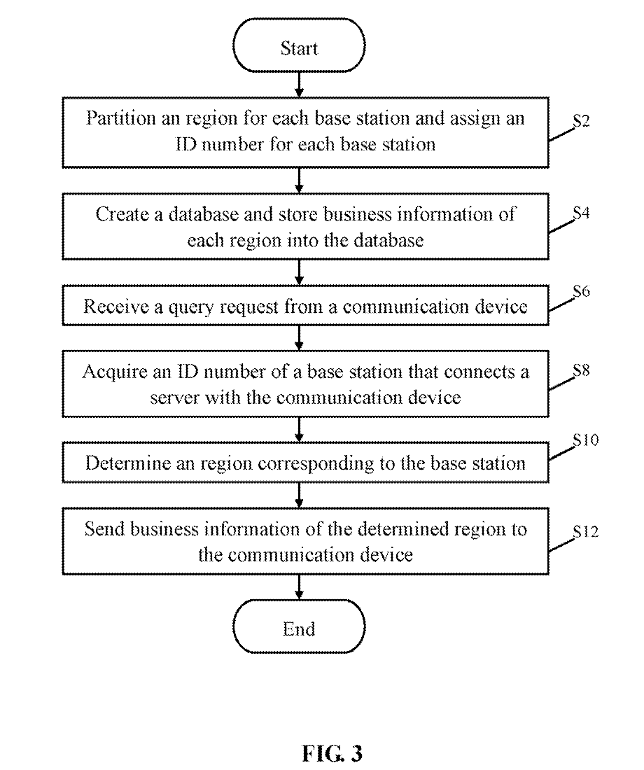

FIG. 3 is a flowchart of one embodiment of a method for providing business information from the server 1 to the communication device 3. Depending on the embodiment, additional blocks may be added, others removed, and the ordering of the blocks may be replaced.

In block S2, the creating module 20 partitions a region for each of the plurality of base stations 4 according to distribution ranges of the plurality of base stations 4 and a cover region of radio signals of each of the plurality of base stations 4, and assigns an ID number for each of the plurality of base stations 4.

In block S4, the creating module 20 creates a database in the storage system 12, and stores business information of a plurality of businesses of each region into the database. As mentioned above, the business information may include names, classifications, addresses, contact phone numbers, and preferential information of various trade companies in each region, for example.

In block S6, when a communication between the communication device 3 and the server 1 is established, the receiving module 22 receives a query request from the communication device 3 through a base station 4 for the purpose to query business information of a region that the base station 4 belongs to. In one embodiment, a user of the communication device 3 (e.g., a mobile phone) may send the query request to the server 1 to ask for business information of a location of the user.

In block S8, the acquiring module 24 acquires an ID number of the base station 4 that connects the server 1 with the communication device 3.

In block S10, the acquiring module 24 determines the region corresponding to the base station 4.

In block S12, the sending module 26 acquires business information of the determined region from the database, and sends the acquired business information to the communication device 3 through the base station 4. In one embodiment, the acquired business information may be “A holiday hotel, near B square, 10% off for hotel rooms” or “C restaurant provides a glass of free champagne for everyone,” for example.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for providing business information from a server to a communication device, the server in communication with the communication device through a plurality of base stations, the method comprising:
partitioning a region for each of the plurality of base stations, and assigning an identification (ID) number for each of the plurality of base stations;
creating a database in a storage system of the server, and storing business information of a plurality of businesses in each region into the database;
receiving a query request from the communication device when a communication between the communication device and the server is established through one of the plurality of base stations;
acquiring an ID number of the base station, and determining a region corresponding to the base station; and
sending business information of the determined region from the server to the communication device through the base station.

2. The method according to claim 1, wherein the business information is sent to the communication device by messages or E-mails.

3. The method according to claim 1, wherein the plurality of base stations are wireless base stations or mobile telephone base stations.

4. The method according to claim 1, wherein the business information comprises names, classifications, addresses, contact phone numbers, and preferential information of various trade companies.

5. The method according to claim 1, further comprising:
presetting query conditions to query the business information.

6. The method according to claim 5, further comprising:
searching the database for the business information according to the preset query conditions; and
sending the searched business information to the communication device.

7. A computing system for providing business information from a server to a communication device, the server in communication with the communication device through a plurality of base stations, the computing system comprising:
a storage system;
at least one processor; and
one or more programs stored in the storage system and being executable by the at least one processor, the one or more programs comprising:
a creating module operable to partition a region for each of the plurality of base stations, assign an identification (ID) number for each of the plurality of base stations, create a database in the storage system, and store business information of a plurality of businesses of each region into the database;
a receiving module operable to receive a query request from the communication device when a communication between the communication device and the server is established through one of the plurality of base stations;
an acquiring module operable to acquire an ID number of the base station, and determine a region corresponding to the base station; and
a sending module operable to send business information of the determined region from the server to the communication device through the base station.

8. The computing system according to claim 7, wherein the business information is sent to the communication device by messages or E-mails.

9. The computing system according to claim 7, wherein the plurality of base stations are wireless base stations or mobile telephone base stations.

10. The computing system according to claim 7, wherein the business information comprises names, classifications, addresses, contact phone numbers, and preferential information of various trade companies.

11. The computing system according to claim 7, wherein the one or more programs further comprises a setting module operable to preset query conditions to query the business information.

12. The computing system according to claim 11, wherein the sending module is further operable to search the database for the business information according to the preset query conditions, and send the searched business information to the communication device.

13. A storage medium storing a set of instructions, the set of instructions capable of being executed by a processor to perform a method for providing business information from a server to a communication device, the server in communication with the communication device through a plurality of base stations, the method comprising:
partitioning a region for each of the plurality of base stations, and assigning an identification (ID) number for each of the plurality of base stations;
creating a database in a storage system of the server, and storing business information of a plurality of businesses of each region into the database;
receiving a query request from the communication device when a communication between the communication device and the server is established through one of the plurality of base stations;
acquiring an ID number of the base station, and determining a region corresponding to the base station; and
sending business information of the determined region from the server to the communication device through the base station.

14. The storage medium as claimed in claim 13, wherein the business information is sent to the communication device by messages or E-mails.

15. The storage medium as claimed in claim 13, wherein the plurality of base stations are wireless base stations or mobile telephone base stations.

16. The storage medium as claimed in claim 13, wherein the business information comprises names, classifications, addresses, contact phone numbers, and preferential information of various trade companies.

17. The storage medium as claimed in claim 13, wherein the method further comprises:
presetting query conditions to query the business information.

18. The storage medium as claimed in claim 17, wherein the method further comprises:
searching the database for the business information according to the preset query conditions; and
sending the searched business information to the communication device.
